(19) United States
(12) Patent Application Publication
(10) Pub. No.: US 2020/0267927 A1
(43) Pub. Date: Aug. 27, 2020

(54) RAISED LITTER BOX ASSEMBLY

(71) Applicant: Rebecca Duncan, Greenville, SC (US)

(72) Inventor: Rebecca Duncan, Greenville, SC (US)

(21) Appl. No.: 16/281,230

(22) Filed: Feb. 21, 2019

(51) Int. Cl. A01K 1/01; A47B 81/00; B65B 67/12; B65F 1/14

(52) U.S. Cl. CPC A01K 1/0107; B65F 1/1415; B65B 67/12; A47B 81/00

(57) ABSTRACT

A raised litter box assembly includes a housing that has bottom wall, a top wall and a perimeter wall that is attached to and extends between the top and bottom walls. The perimeter wall includes a front wall, a back wall, a fist lateral wall and a second lateral wall. The top wall has a basin formed therein. The front wall has an access opening therein for accessing an interior of the housing. A plurality of legs is attached to the bottom wall and extends downwardly therefrom. A ramp is attached to the housing adjacent to a juncture of the first lateral wall and the top wall. The ramp extends downwardly from the housing a distance equal to a distance extending from the top wall to a bottom of the legs.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to litter box systems and more particularly pertains to a new litter box system for holding litter box in an easily accessible location for a caretaker of a cat.

### BRIEF SUMMARY OF THE INVENTION

An embodiment of the disclosure meets the needs presented above by generally comprising a housing that has bottom wall, a top wall and a perimeter wall that is attached to and extends between the top and bottom walls. The perimeter wall includes a front wall, a back wall, a fist lateral wall and a second lateral wall. The top wall has a basin formed therein. The front wall has an access opening therein for accessing an interior of the housing. A plurality of legs is attached to the bottom wall and extends downwardly therefrom. A ramp is attached to the housing adjacent to a juncture of the first lateral wall and the top wall. The ramp extends downwardly from the housing a distance equal to a distance extending from the top wall to a bottom of the legs.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right and top isometric view of a raised litter box assembly according to an embodiment of the disclosure.

FIG. 2 is a front view of an embodiment of the disclosure.

FIG. 3 is a rear view of an embodiment of the disclosure.

FIG. 4 is an exploded top and left isometric view of an embodiment of the disclosure.

FIG. 5 is a right and top isometric view of an embodiment of the disclosure.

### DETAILED DESCRIPTION OF THE INVENTION

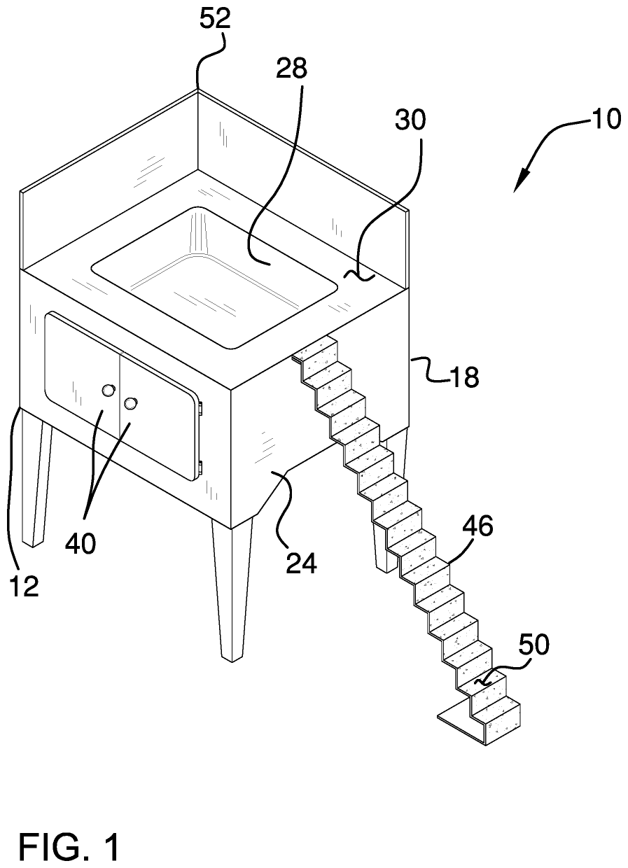

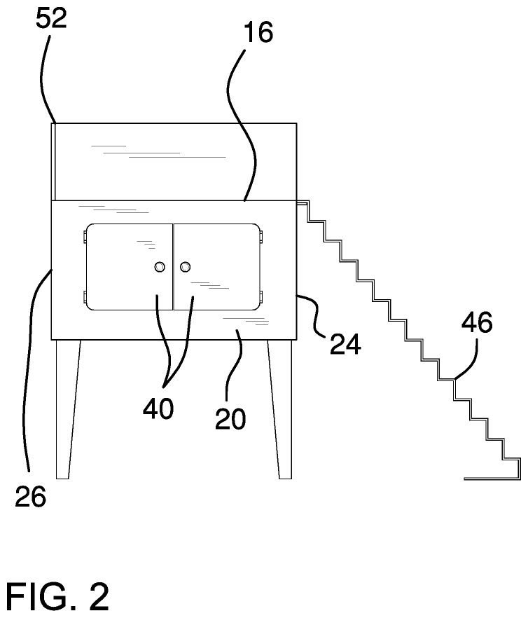

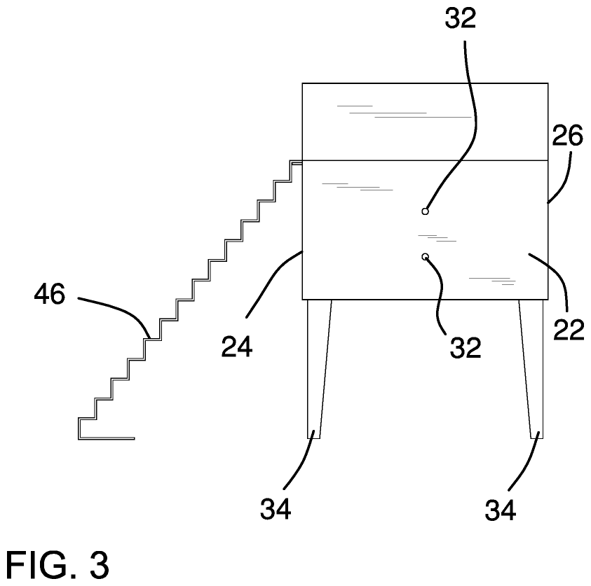

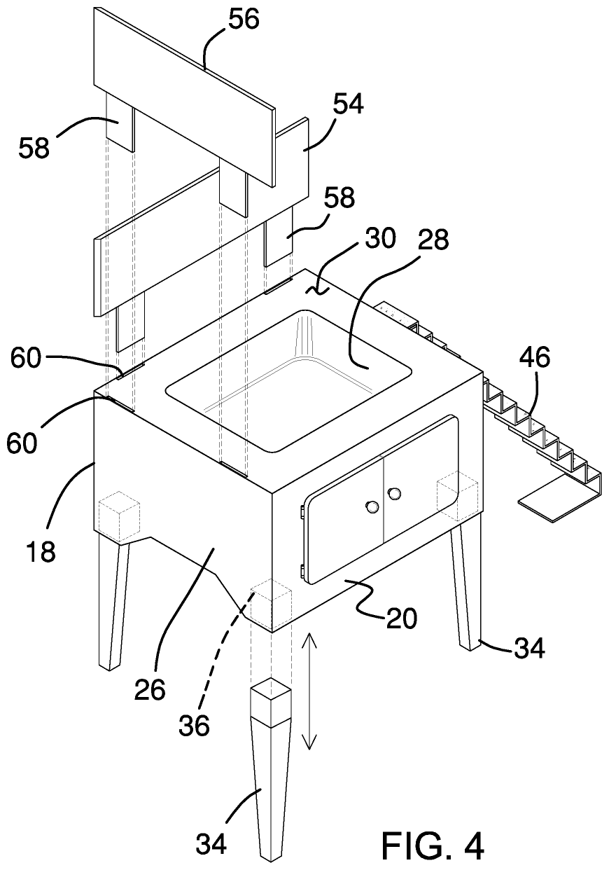

With reference now to the drawings, and in particular to FIGS. 1 through 5 thereof, a new litter box system embodying the principles and concepts of an embodiment of the disclosure and generally designated by the reference numeral 10 will be described.

As best illustrated in FIGS. 1 through 5, the raised litter box assembly 10 generally comprises a housing 12 that has bottom wall 14, a top wall 16 and a perimeter wall 18 that is attached to and extends between the top 16 and bottom 14 walls. The perimeter wall 18 includes a front wall 20, a back wall 22, a fist lateral wall 24 and a second lateral wall 26. The top wall 16 has a basin 28 formed therein and a ledge 30 is defined on the top wall 16 between the basin 28 and the perimeter wall 18. The ledge 30 will typically have a width equal to at least 5.0 inches continuously extending around the basin. The housing 12 has a length from the first lateral wall 24 to the second lateral wall 26 that is equal to at least 30.0 inches, and a width from the front wall 20 to the back wall 22 is equal to at least 22.0 inches. More particularly, the top wall 16 may have a size equal to 36.0 inches long and 25.0 inches wide. The basin 28 has a depth between 8.0 inches and 20.0 inches. The back wall 22 has at least one aperture 32 extending therethrough configured to receive an anchoring member to anchor the housing 12 to a wall. The anchoring member may comprise a screw that is extended through the aperture 30 and into a dwelling wall. As can be seen in the Figures, more than one aperture 30 may be provided. The housing 12 may be comprised of a rigid, but lightweight material such as plastic and may be provided in any desired color.

A plurality of legs 34 is attached to the bottom wall 14 and extend downwardly therefrom. The legs 34 position the top wall 16 between 30″ inches and 42″ above a ground surface supporting the legs 34. The legs 34 may be removable from the housing 12 and more particularly may be removably extended into sockets 36 in the bottom wall 14. This will allow the legs 34 to be removed easily for storage and transportation purposes.

The front wall 20 has an access opening 38 therein for accessing an interior of the housing 12. This allows the interior of the housing 12 to be used for storing litter, waste bags, scoops and other items required by a user of the assembly 10. A pair of doors 40 is hingedly coupled to the front wall 20 and are positionable in a closed position closing the access opening 38 or in an open position exposing the access opening 38.

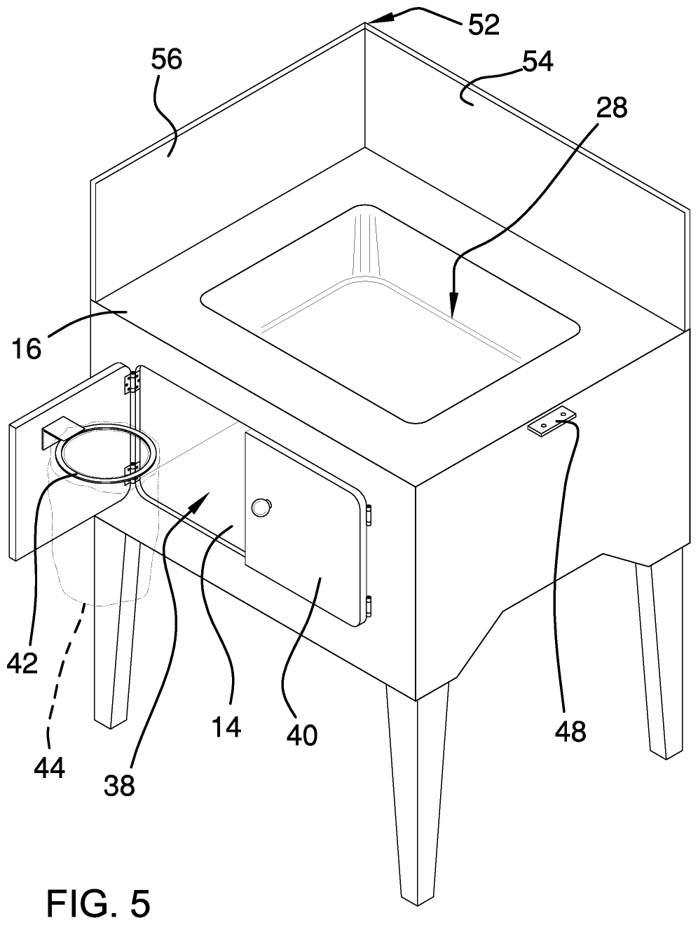

A bag supporting member 42, such as a ring, is attached to an inner surface of one of the doors 40. The bag supporting member 42 is configured to hold a bag 44 in an open configuration for receiving waste litter from the basin 28. As can be seen in FIG. 5, this will facilitate the ability of a user to simply scoop the material directly from the basin 28 into the bag 44.

A ramp 46 is attached to the housing 12 adjacent to a juncture of the first lateral wall 24 and the top wall 16. A mounting cleat 48 may be provided for engaging the ramp 46 wherein the mounting cleat 48 is attached directly to the housing 12. The ramp 46 extends downwardly from the housing 12 a distance equal to a distance extending from the top wall 16 to a bottom of the legs 34. The ramp 46 will have a width being less than 6.0 inches to discourage other animals, such as dogs, from attempting to climb the ramp 46. The ramp 46 may comprise a plurality of steps. Each of the steps has an upper surface 50 having a claw engageable material thereon configured to allow a cat to grip the ramp with claws. The claw engageable material may include, for example, twine embedded into the upper surface. This may be combined with reinforced cardboard materials, though reinforced cardboard may be used without the twine. Essentially, any tight fibrous material which is engageable with a cat's claws may be utilized.

A backsplash 52 is attached to the top wall 16 adjacent to the perimeter wall 18 and extends upwardly therefrom. The backsplash 52 includes a rear wall 54 extending upwardly from the back wall 22 and a side wall 56 extending upwardly from the second lateral wall 26 wherein only the back wall 22 and the second lateral wall 26 have the backsplash 52 positioned adjacent thereto. That is, a front and first lateral side of the housing 12 do not include the backsplash 52. However, the backsplash 52 prevents litter or urine spray from striking dwelling walls against which the housing 12 is positioned. The backsplash 52 may be removably attached to the top wall by utilizing tongues 58 on the backsplash 52 that are extendable into grooves 60 in the top wall 16.

In use, the assembly 10 allows for easy access to a cat's litter for cleaning and refiling purposes. The housing 12 provides a storage space for all items needed for the litter box while the basin 28 holds litter that is accessible by a cat which travels up the ramp 46. By lifting the housing 10 upwardly, the assembly 10 reduces the chances that a caretaker of a cat will injure themselves while cleaning or changing litter.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cat litter box assembly comprising:
a housing having bottom wall, a top wall and a perimeter wall being attached to and extending between said top and bottom walls, said perimeter wall including a front wall, a back wall, a fist lateral wall and a second lateral wall, said top wall having a basin formed therein;
said front wall having an access opening therein for accessing an interior of said housing;
a plurality of legs being attached to said bottom wall and extending downwardly therefrom; and
a ramp being attached to said housing adjacent to a juncture of said first lateral wall and said top wall, said ramp extending downwardly from said housing a distance equal to a distance extending from said top wall to a bottom of said legs.

2. The cat litter box assembly according to claim 1, wherein a ledge is defined on said top wall between said basin and said perimeter wall, said ledge having a width equal to at least 5.0 inches continuously extending around said basin.

3. The cat litter box assembly according to claim 1, wherein said housing having a length from said first lateral wall to said second lateral wall being equal to at least 30.0 inches, said housing having a width from said front wall to said back wall being equal to at least 22.0 inches, said basin having a depth between 8.0 inches and 20.0 inches.

4. The cat litter box assembly according to claim 1, wherein said back wall has at least one aperture extending therethrough configured to receive an anchoring member to anchor said housing to a wall.

5. The cat litter box assembly according to claim 1, further including a pair of doors being hingedly coupled to said front wall and being positionable in a closed position closing said access opening or in an open position exposing said access opening.

6. The cat litter box assembly according to claim 1, wherein said legs position said top wall between 30″ inches and 42″ above a ground surface supporting said legs.

7. The cat litter box assembly according to claim 5, further including a bag supporting member being attached to an inner surface of one of said doors, said bag supporting member being configured to hold a bag in an open configuration for receiving waste litter from said basin.

8. The cat litter box assembly according to claim 1, wherein said ramp comprises a plurality of steps.

9. The cat litter box assembly according to claim 8, wherein each of said steps has an upper surface having a claw engageable material thereon configured to allow a cat to grip said ramp with claws.

10. The cat litter box assembly according to claim 1, further including a backsplash being attached to said top wall adjacent to said perimeter wall and extending upwardly therefrom.

11. The cat litter box assembly according to claim 10, wherein said backsplash includes a rear wall extending upwardly from said back wall and a side wall extending upwardly from said second lateral wall, wherein only said back wall and said second lateral wall have said backsplash positioned adjacent thereto, said backsplash being removably attached to said top wall.

12. A cat litter box assembly comprising:
a housing having bottom wall, a top wall and a perimeter wall being attached to and extending between said top and bottom walls, said perimeter wall including a front wall, a back wall, a fist lateral wall and a second lateral wall, said top wall having a basin formed therein, a ledge being defined on said top wall between said basin and said perimeter wall, said ledge having a width equal to at least 5.0 inches continuously extending around said basin, said housing having a length from said first lateral wall to said second lateral wall being equal to at least 30.0 inches, said housing having a width from said front wall to said back wall being equal to at least 22.0 inches, said basin having a depth between 8.0 inches and 20.0 inches, said back wall having at least one aperture extending therethrough configured to receive an anchoring member to anchor said housing to a wall;
said front wall having an access opening therein for accessing an interior of said housing, a pair of doors being hingedly coupled to said front wall and being positionable in a closed position closing said access opening or in an open position exposing said access opening;
a plurality of legs being attached to said bottom wall and extending downwardly therefrom, wherein said legs position said top wall between 30″ inches and 42″ above a ground surface supporting said legs, said legs being removably extended into sockets in said bottom wall;
a bag supporting member being attached to an inner surface of one of said doors, said bag supporting member being configured to hold a bag in an open configuration for receiving waste litter from said basin;
a ramp being attached to said housing adjacent to a juncture of said first lateral wall and said top wall, said ramp extending downwardly from said housing a distance equal to a distance extending from said top wall to a bottom of said legs, said ramp comprising a plurality of steps, each of said steps having an upper surface having a claw engageable material thereon configured to allow a cat to grip said ramp with claws; and
a backsplash being attached to said top wall adjacent to said perimeter wall and extending upwardly therefrom, said backsplash including a rear wall extending upwardly from said back wall and a side wall extending upwardly from said second lateral wall, wherein only said back wall and said second lateral wall have said backsplash positioned adjacent thereto, said backsplash being removably attached to said top wall.
